(19) United States
(12) Patent Application Publication
(10) Pub. No.: US 2007/0197224 A1
(43) Pub. Date: Aug. 23, 2007

(54) Client server outgoing call management system

(75) Inventor: Yair Winkler, Caesarea (IL)

Correspondence Address: BROWDY AND NEIMARK, P.L.L.C.;624 NINTH STREET, NW, SUITE 300, WASHINGTON, DC, 20001-5303, US

(73) Assignee: Festin Enterprises Corporation, Der Stadt (PA)

(21) Appl. No.: 11/357,213

(22) Filed: Feb. 21, 2006

(51) Int. Cl. H04Q 7/20

(52) U.S. Cl. 455/445

(57) ABSTRACT

The present invention provides a communication system and methods comprising a mobile terminal originating a service call to a communication server, instructing the communication server to take specific actions. When the user of the mobile terminal dials out a destination number, adapted software or hardware logic on the mobile terminal intercepts the destination dial-out number, stores it in a temporary buffer and originates a service call instead to the predefined communication server. The service call contains a command message and a destination dial-out number. The mobile terminal broadcasts the command message and destination dial-out number to the server via signals, preferably voice signals, and most preferably DTMF signals.

### FIELD OF THE INVENTION

The present invention relates to a communication system and methods wherein a mobile terminal dialing out a destination number generates a service call to a communication server, and wherein the communication server acts upon instructions received by said service call.

### BACKGROUND OF THE INVENTION

Mobile phones charges can be quite steep when a subscriber is located outside the influence zone of the mobile phone operator's network to which he subscribes to. When a user travels, for example, to a different country, he may be able to use his mobile phone to originate and receive calls only if his original mobile phone operator has special agreements, known in the art as “roaming agreements”, to let its own users use a different network for initial connection.

For example, mobile phone user A subscribes to a mobile network operator B. While A is traveling outside the physical area where mobile operator B is operating its mobile network, user A might be able to connect to mobile operator C operating in said area, only if Operator B has commercial roaming agreements with Operator C. In this case, A would be allowed to use the C network to place and receive calls.

It happens, in many cases, that roaming charges for receiving and placing calls on a mobile phone while temporarily connected to a different network than the one the user has subscribed to, can be very high. Even in cases where a user does not pay for receiving calls on his mobile phone while in his home network—a commercial option known as calling party pays (CPP)—the user might still be charged for receiving calls when roaming, since mobile operator C has to be paid in addition to mobile operator B.

When roaming, the difference between charges of incoming and outgoing calls can be very significant, sometimes at a ratio of 1:7 or even more. This situation has created opportunities for methods of communication where user A connects to user B, via a third party, and is not exposed to arbitrary roaming charges, and where some costs can be controlled and reduced significantly.

Accordingly, there is a strong need to enable the mobile phone user to control and reduce the costs of outgoing calls by dialing through a predefined communication server.

### SUMMARY OF THE INVENTION

The present invention provides a communication system and methods, the communication system comprising a mobile terminal originating a service call to a communication server, wherein the mobile terminal contains software or hardware logic adapted to generate a service call comprising a command message and a destination dial-out number. The interaction between said communication server and said mobile terminal is carried out by the following steps: the user of the mobile terminal dials out a destination dial-out number he wants to reach. Adapted software or hardware logic on the mobile terminal stores the destination dial-out number in a temporary buffer and dials out instead a predefined number for the communication server. The communication server rejects the incoming call from the mobile terminal and immediately calls back the mobile terminal. Then the communication server sends a server message to the mobile terminal informing that it is ready to receive commands. The mobile terminal broadcasts signals, preferably voice signals, most preferably Dual Tone Multi-Frequency (DTMF) signals, to the communication server with the command message and dial-out destination number. The communication server receives and analyzes the command message, and then sends a server message to the mobile terminal informing that the command message was well received, and that the mobile terminal should stop broadcasting signals to the communication server. The communication server acts upon the command message.

Command messages instruct the communication server to perform one of the following actions: to call the destination number and to connect said destination number with the mobile terminal originating the service call (Call Through); or to connect the mobile terminal originating the service call with an information service (Play Content); or to perform specific data services (Data Transaction); or to disconnect the service call and to call back a new number provided by the service call, and then connect said new number to said destination number to be dialed to (Callback on a Different Number).

### BRIEF DESCRIPTION OF THE FIGURES

FIG. 1 illustrates a block diagram of the information exchange inside a service call between a mobile terminal and a communication server

FIG. 2 illustrates a block diagram of a mobile terminal connecting to a communication device via a communication server.

FIG. 3 illustrates a block diagram of a mobile terminal connecting to an information service via a communication server.

FIG. 4 illustrates a block diagram of a mobile terminal connecting to a data server via a communication server.

FIG. 5 illustrates a block diagram of a mobile terminal requesting a communication server to call it back on a different number.

FIG. 6 illustrates a block diagram of the entire communication system, showing together all the actions described in FIGS. 1-5.

FIG. 7 illustrates a flow chart of the entire process, from the call initiation until the action resulted.

### DETAILED DESCRIPTION OF THE INVENTION

In the following detailed description of various embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

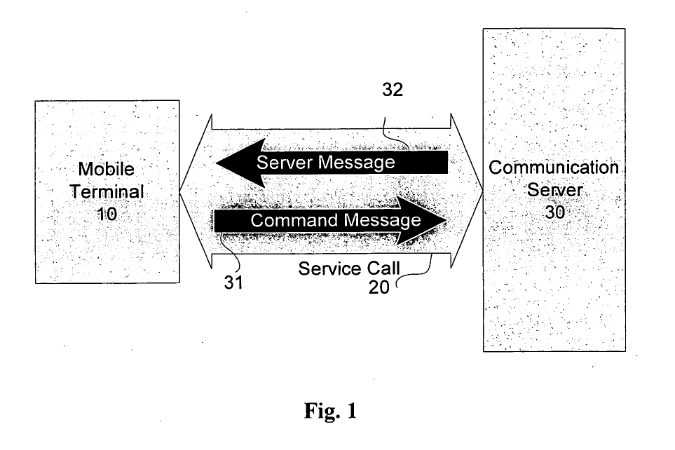

FIG. 1 shows a communication system comprising a mobile terminal 10 originating a service call 20 to a predefined communication server 30, wherein the mobile terminal 10 contains software or hardware logic adapted to generate a service call 20 comprising a command message 31 and a destination dial-out number, wherein the interaction between said communication server 30 and said mobile terminal 10 is carried out by the following steps:

i) the user of the mobile terminal 10 dials out the destination dial-out number;

ii) the adapted software or hardware logic on the mobile terminal 10, stores the destination dial-out number in a temporary buffer and dials out instead a predefined number for the communication server 30;

iii) the communication server 30 rejects the incoming call from the mobile terminal 10 and immediately calls back said mobile terminal 10;

iv) the communication server 30 sends a server message 32 to the mobile terminal 10 informing that it is ready to receive commands;

v) the mobile terminal 10 broadcasts signals to the communication server with the command message 31 and dial-out destination number;

vi) the communication server 30 receives and analyzes the command message 31, and then sends a server message 32 to the mobile terminal 10 informing that the command message 31 was well received, and that the mobile terminal 10 should stop broadcasting signals to the communication server 30; and

vii) the communication server 30 acts upon the command message 31.

In one preferred embodiment of the invention, the mobile terminal 10 uses voice signals to broadcast command messages 31 to the communication server 30.

In a most preferred embodiment of the invention, the voice signals used by the mobile terminal 10 to broadcast command messages 31 to the communication server 30 are Dual Tone Multi-Frequency (DTMF) signals.

In another embodiment of the invention the communication server 30 sends server messages 32 to the mobile terminal 10 by at least one of the messaging services selected from the group consisting of: Short Message Service (SMS), Enhanced Message Service (EMS), Multimedia Message Service (MMS), e-mail, and Instant Message (IM).

In one preferred embodiment of the invention the communication server 30 sends server messages 32 to the mobile terminal 10 by Short Message Service (SMS).

In order to generate the right service call 20 the mobile terminal 10 is equipped with adapted software or hardware logic. The said logic determines the assigned number to call the communication server 30.

In one preferred embodiment of the invention, the logic adapted to generate service calls 20 by the mobile terminal 10 is placed within the Subscriber Identification Module (SIM) card of said mobile terminal 10.

In another preferred embodiment of the invention, the adapted logic performs an update session Over The Air (OTA) with the communication server 30, the first time the mobile terminal 10 is turned on with the adapted software or hardware logic in it. The session update receives the geographic location from the communication server 30 by using an HLR VLR process interrogation. In yet another embodiment of the invention, the session update also receives the local phone number for the communication server 30 at the current country or a specific global number for the communication server 30 or both numbers.

In a further embodiment of the invention, the logic adapted to generate service calls 20 by the mobile terminal 10 is placed within an attached memory device of said mobile terminal 10.

In another embodiment of the invention, the logic adapted to generate service calls 20 is downloaded from an external source wherein said external source is the Internet, a corporate network, a commercial network, a personal computer or a mobile terminal.

In another aspect of this invention, the mobile terminal 10 originates a service call 20 comprising a command message 31 and a destination dial-out number, to a communication server 30, whereby the command message 31 instructs said communication server 30 to act upon said command message 31 by performing one of the following actions: Call Through, Play Content, Data Transaction, or Callback on a Different Number.

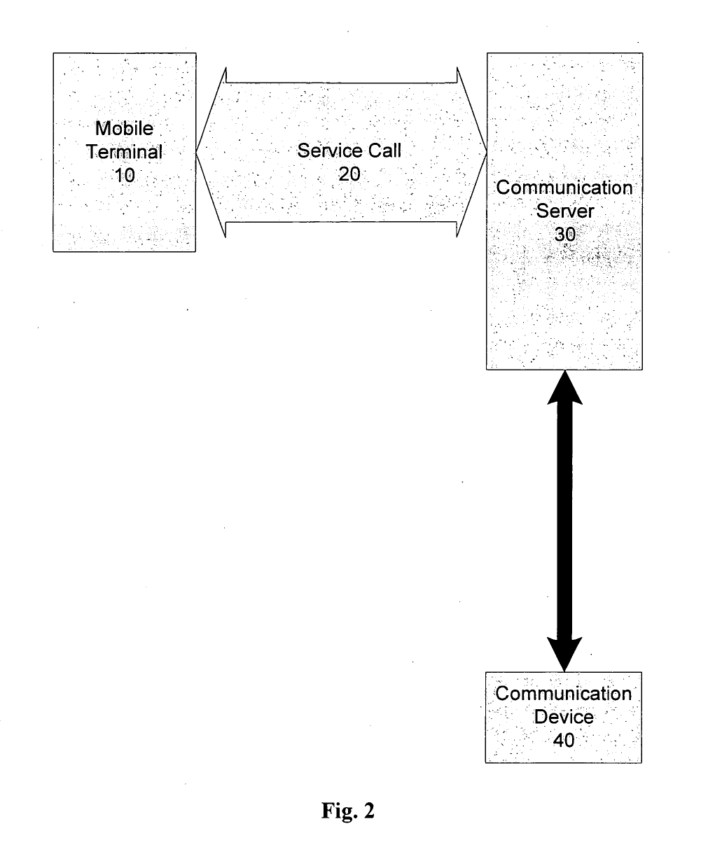

FIG. 2 shows the Call Through process where a mobile terminal 10, which generates a service call 20 to a predefined communication server 30, instructs the communication server 30 to establish a connection to the destination number of communication device 40 and then connect between said mobile terminal 10 and said communication device 40.

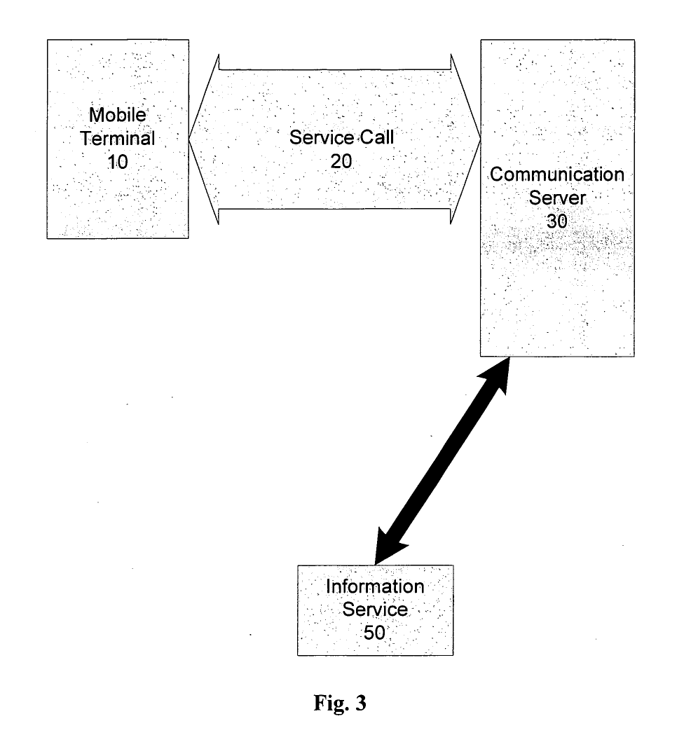

FIG. 3 shows the Play Content process where a mobile terminal 10, which generates a service call 20 to a predefined communication server 30, instructs the communication server 30 to establish a connection to an information service 50, preferably news, entertainment, general information, corporate information, financial information, or access to a voicemail system, and then connect between said mobile terminal 10 and said information service 50.

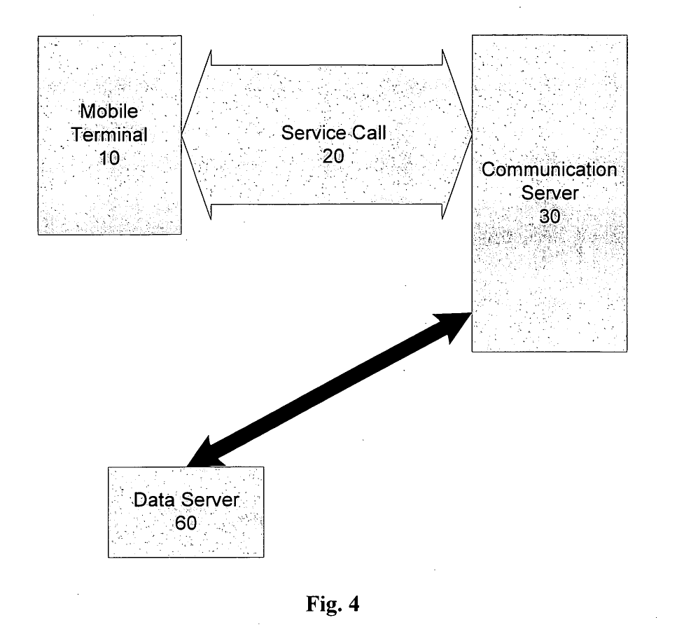

FIG. 4 shows the Data Transaction process where a mobile terminal 10, which generates a service call 20 to a predefined communication server 30, instructs the communication server 30 to establish a connection to a data server 60 and then connect between said mobile terminal 10 and said data server 60 to perform data services.

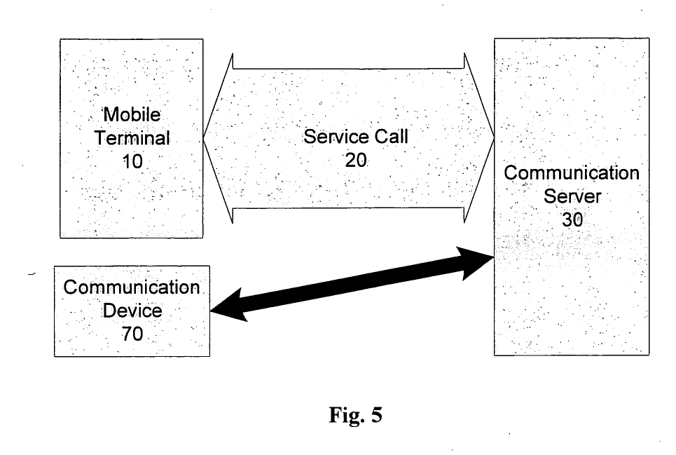

FIG. 5 shows the Callback on a Different Number process where a mobile terminal 10, which generates a service call 20 to a predefined communication server 30, instructs the communication server 30 to disconnect the ongoing service call 20 and then establish a new connection to a communication device 70, using a new number provided by the service call 20. The communication server 30 then proceeds to complete the call in one of the manners described by FIGS. 2-4.

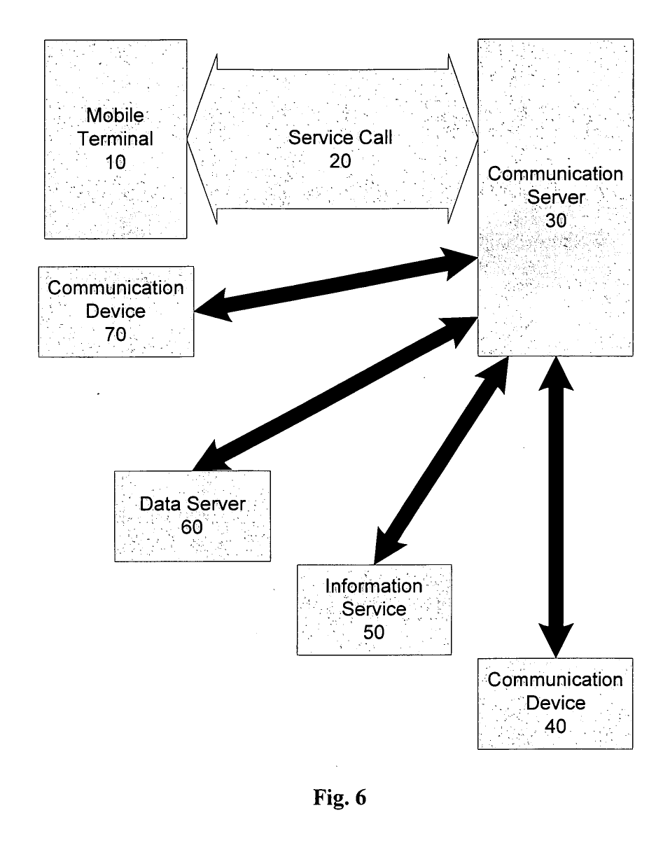

FIG. 6 shows an entire view of the communication system described in FIGS. 1-5 where a mobile terminal 10 generates a service call 20 to a predefined communication server 30. During the service call 20, the communication server 30 sends a server message 32 to the mobile terminal 10, to inform it to start sending instructions. The mobile terminal 10 then starts broadcasting a command message 31 to the communication server 30. After receiving and analyzing the command message 31, the communication server 30, sends out another server message 32 to inform the mobile terminal 10 to stop broadcasting command messages 31. The command message 31 instructs the communication server 30 to perform one of the following actions:

a) Call Through—The communication server 30 establishes a connection to the destination number of communication device 40 and then connects between the mobile terminal 10 and said communication device 40.

b) Play Content—The communication server 30 establishes a connection to an information service 50, preferably news, entertainment, general information, corporate information, financial information, or access to a voicemail system, and then connects between the mobile terminal 10 and said information service 50.

c) Data Transaction—The communication server 30 establishes a connection to a data server 60 and then connects between the mobile terminal 10 and said data server 60 to perform data services.

d) Callback on a Different Number—The communication server 30 disconnects the ongoing service call 20 and then establishes a new connection to a communication device 70, using a new number provided by the service call 20. The communication server 30 then proceeds to complete the call by executing one of the actions described above: Call Through, Play Content, or Data Transaction.

In one embodiment of the invention, the communication server 30, while dialing another communication device 40 or 70, can specify a telephone extension or a room number. In one preferred embodiment of the invention, the said telephone extension or room numbers are specified by using voice recordings or signals.

In one preferred embodiment of the invention, the information service 50 provides news, entertainment, general information, corporate information, financial information, or access to a voicemail system.

In another preferred embodiment of the present invention, the transaction with the data server 60 includes additional information provided by the service call 20. Said additional information comprises of passwords, personal information numbers (PIN), data service parameters or user preferences.

In yet a further embodiment of the invention, the communication server 30 plays the sound of a dial tone while connecting to the destination number, thus creating the impression that the mobile terminal 10 is dialing directly the said destination number.

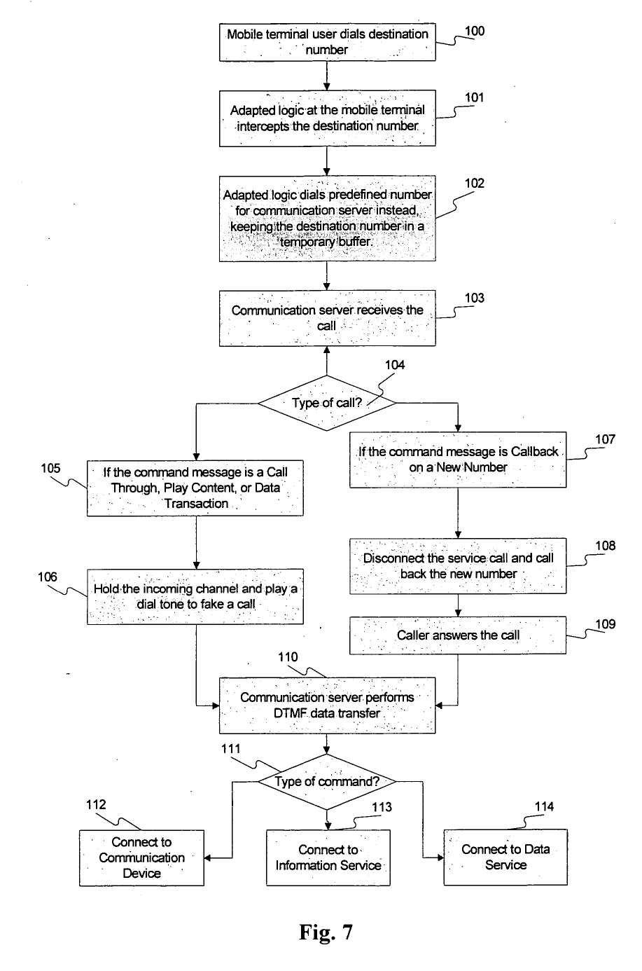

FIG. 7 shows a flow chart of the entire process. The process starts when the user of the mobile terminal dials out a destination number 100. Adapted software or hardware at the mobile terminal then intercepts the destination number 101 and dials out instead a predefined number 102 for the communication server 30 keeping the original destination dial-out number in a temporary buffer. The communication server 30 receives the call 103, and then determines what type of call it is 104.

If the command message 31 is either Call Through, Play Content, or Data Transaction 105 then the communication server 30 holds the incoming channel and plays a dial tone to fake an outgoing call 106.

If the command message 31 is Callback on a New Number 107, then the communication server 30 disconnects the service call 20 and calls back a new number 108 provided by the service call 20. The caller then answers the call on said new number.

At this stage, either after playing the dial tone to fake an outgoing call 106, or after calling back the new number 108 and having the user pick up the call 109, the communication server performs the data transfer 110 with the mobile terminal 10. The communication server then examines the type of command message 31 addressed to it 111, and executes accordingly either by connection to another communication device 112, connecting to an information service 113, or by connecting to a data server 114 and performing a data transaction.

In another aspect, the present invention relates to a communication system comprising a mobile terminal 10 and a communication server 30, wherein the mobile terminal 10 contains software or hardware logic adapted to contact said communication server 30, and the interaction between said communication server 30 and said mobile terminal 10 is carried out by the following steps:

i. the user of the mobile terminal 10 dials out a destination dial-out number;

ii. the adapted software or hardware logic on the mobile terminal 10 stores the destination dial-out number in a temporary buffer and dials out instead a first communication server number;

iii. the communication server 30 rejects the first incoming call from the mobile terminal 10;

iv. the adapted software or hardware logic on the mobile terminal 10 then dials out a second communication server number;

v. the communication server 30 rejects the second incoming call from the mobile terminal 10;

vi. the communication server 30 deducts, based on said first communication server number dialed and said second communication server number dialed, the telephone number of the mobile terminal 10 and the destination dial-out number dialed by the user of said mobile terminal 10;

vii. the communication server 30 then calls back said mobile terminal 10;

viii. the communication server 30 then calls the destination dial-out number; and

ix. the communication server 30 then connects the destination dial-out number and said mobile terminal 10.

The communication server 30 is allocated with a large number of virtual telephone numbers. A virtual telephone number is any valid telephone number that can be successfully dialed and terminated at a local telephone number. For example, 3 virtual telephone numbers 1-800-1234-567, 1-800-1122-3344 and 1-512-646-6464 may all terminate at a single local telephone number, for example 1-512-333-4444. Thus calling any of the three virtual numbers will all ring at 1-512-333-4444. Of course, one may also dial the local number 1-512-333-4444 directly. Virtual numbers are useful for several purposes, for example when a company advertises in different venues, each with a different telephone number. All calls terminate at one local number but by capturing which virtual number is dialed, the company can measure the effectiveness of each advertising venue.

The communication server 30 of the invention uses the pool of virtual communication server numbers in order to allow the mobile terminal 10 to dial out a first and second communication server numbers selected from a large number of available virtual phone numbers. The adapted software or hardware logic on the mobile terminal 10 selects the first and second communication server numbers to call based on the own telephone number of the mobile terminal 10 and the destination dial-out number.

The communication server 30 monitors the pool of virtual numbers and identifies when a first and a second communication server numbers have been dialed by a mobile terminal 10. In practice, a communication server 30 services many mobile terminals 10. When the communication server 30 receives (and rejects) a call to one of the communication server numbers in said pool of virtual numbers, the communication server 30 is not aware if the received call is a first incoming call from a mobile terminal 10 or actually a second call. As a result, the communication server 30 constantly monitors the incoming calls, and identifies valid pairs of incoming calls corresponding to a first and a second communication server numbers dialed by one given mobile terminal 10. Based on the unique pair of a first and second communication server numbers dialed, the communication server 30 is able to unequivocally deduct the telephone number of the calling mobile terminal 10 and the destination dial-out number dialed by the user of said mobile terminal 10. The communication server 30 is thus able to connect the mobile terminal 10 to the destination dial-out number.

Although the invention has been described in detail, nevertheless changes or modifications which do not depart from the teachings of the present invention will be evident to those skilled in the art. Such changes and modifications are deemed to come within the purview of the present invention and the appended claims.

1. A communication system comprising a mobile terminal originating a service call to a communication server, wherein the mobile terminal contains software or hardware logic adapted to generate a service call comprising a command message and a destination dial-out number, wherein the interaction between said communication server and said mobile terminal is carried out by the following steps:
i) the user of the mobile terminal dials out the destination dial-out number;
ii) the adapted software or hardware logic on the mobile terminal, stores the destination dial-out number in a temporary buffer and dials out instead a predefined number for the communication server;
iii) The communication server rejects the incoming call from the mobile terminal and immediately calls back said mobile terminal;
iv) the communication server sends a server message to the mobile terminal informing that it is ready to receive commands;
v) the mobile terminal broadcasts signals to the communication server with the command message and dial-out destination number;
vi) the communication server receives and analyzes the command message, and then sends a server message to the mobile terminal informing that the command message was well received, and that the mobile terminal should stop broadcasting signals to the communication server; and
vii) the communication server acts upon the command message.

2. The communication system according to claim 1, wherein the signals used to broadcast the command message from the mobile terminal to the communication servers are voice signals.

3. The communication system according to claim 2, wherein the voice signals used to broadcast the command message from the mobile terminal to the communication server are Dual Tone Multi-Frequency (DTMF) signals.

4. The communication system according to claim 1, wherein the communication server sends server messages to the mobile terminal by at least one of the messaging services selected from the group consisting of: Short Message Service (SMS), Enhanced Message Service (EMS), Multimedia Message Service (MMS), e-mail, and Instant Message (IM).

5. The communication system according to claim 4, wherein the communication server sends server messages to the mobile terminal by Short Message Service (SMS).

6. The communication system according to claim 1, wherein the logic adapted to generate service calls is placed within the Subscriber Identification Module (SIM) card of said mobile terminal.

7. The communication system according to claim 1, wherein the logic adapted to generate service calls performs an update session Over The Air (OTA) the first time the mobile terminal is turned on with the adapted logic in it, in order to receive local and global parameters update regarding the service call.

8. The communication system according to claim 1, wherein the logic adapted to generate service calls is placed within an attached memory device of said mobile terminal.

9. The communication system according to claim 1, wherein the logic adapted to generate service calls is downloaded from an external source.

10. The communication system according to claim 9, wherein the external source used to download the logic adapted to generate service calls is the Internet, a corporate network, a commercial network, a personal computer or a mobile terminal.

11. A communication system according to claim 1, wherein the service call is broadcast from the mobile terminal to the communication server by using Dual Tone Multi-Frequency (DTMF) signals.

12. A communication system according to claim 1, whereby the command message instructs said communication server to act upon said command message in one of the following ways:
i) to call the destination number and to connect said destination number with the mobile terminal originating the service call;
ii) to connect the mobile terminal originating the service call with an information service;
iii) to perform specific data services; or
iv) to disconnect the service call and to call back a new number provided by the service call, and then connect said new number to said destination number to be dialed to.

13. The communication system according to claim 12, wherein the communication server plays the sound of a dial-tone while connecting to the destination number, thus creating the impression that the mobile terminal is dialing directly the said destination number.

14. The communication system according to claim 12, wherein said information service provides news, entertainment, general information, corporate information, financial information, or access to a voicemail system.

15. The communication system according to claim 12, wherein said data services include additional information provided by the service call.

16. The communication system according to claim 15, wherein said additional information provided by the service call comprises of passwords, personal information numbers (PIN), data service parameters, or user preferences.

17. The communication system according to claim 12, wherein said communication server dialing a new number, after disconnecting the service call, specifies an extension or a room number by adding voice recordings or voice signals.

18. The communication system according to claim 12, wherein the communication server dialing a new number, after disconnecting the service call, dials back to said mobile terminal.

19. A communication system comprising a mobile terminal originating a service call to a communication server, wherein the mobile terminal contains software or hardware logic adapted to generate a service call comprising a command message and a destination dial-out number, wherein the interaction between said communication server and said mobile terminal is carried out by the following steps:
i) the user of the mobile terminal dials out the destination dial-out number;
ii) the adapted software or hardware logic on the mobile terminal, stores the destination dial-out number in a temporary buffer and dials out instead a predefined number for the communication server;
iii) the communication server rejects the incoming call from the mobile terminal and immediately calls back said mobile terminal;
iv) the communication server sends a server message to the mobile terminal informing that it is ready to receive commands;
v) the mobile terminal broadcasts voice signals to the communication server with the command message and dial-out destination number;
vi) the communication server receives and analyzes the command message, and then sends a server message to the mobile terminal informing that the command message was well received, and that the mobile terminal should stop broadcasting signals to the communication server; and
vii) the communication server acts upon the command message.

20. The communication system according to claim 12, wherein the voice signals used to broadcast the command message from the mobile terminal to the communication servers are Dual Tone Multi-Frequency (DTMF) signals.

21. The communication system according to claim 12, wherein the communication server sends server messages to the mobile terminal by at least one of the messaging services selected from the group consisting of: Short Message Service (SMS), Enhanced Message Service (EMS), Multimedia Message Service (MMS), e-mail, and Instant Message (IM).

22. The communication system according to claim 21, wherein the communication server sends server messages to the mobile terminal by Short Message Service (SMS).

23. The communication system according to claim 12, wherein the logic adapted to generate service calls is placed within the Subscriber Identification Module (SIM) card of said mobile terminal.

24. A communication system comprising a mobile terminal originating a service call to a communication server, wherein the mobile terminal contains software or hardware logic adapted to generate a service call comprising a command message and a destination dial-out number, wherein the interaction between said communication server and said mobile terminal is carried out by the following steps:
i) the user of the mobile terminal dials out the destination dial-out number;
ii) the adapted software or hardware logic on the mobile terminal, stores the destination dial-out number in a temporary buffer and dials out instead a predefined number for the communication server;
iii) the communication server rejects the incoming call from the mobile terminal and immediately calls back said mobile terminal;
iv) the communication server sends a server message to the mobile terminal informing that it is ready to receive commands;
v) the mobile terminal broadcasts Dual Tone Multi-Frequency (DTMF) signals to the communication server with the command message and dial-out destination number;
vi) the communication server receives and analyzes the command message, and then sends a server message to the mobile terminal informing that the command message was well received, and that the mobile terminal should stop broadcasting signals to the communication server; and
vii) the communication server acts upon the command message.

25. The communication system according to claim 24, wherein the communication server sends server messages to the mobile terminal by at least one of the messaging services selected from the group consisting of: Short Message Service (SMS), Enhanced Message Service (EMS), Multimedia Message Service (MMS), e-mail, and Instant Message (IM).

26. The communication system according to claim 25, wherein the communication server sends server messages to the mobile terminal by Short Message Service (SMS).

27. The communication system according to claim 24, wherein the logic adapted to generate service calls is placed within the Subscriber Identification Module (SIM) card of said mobile terminal.

28. A method for interaction between a mobile terminal and a communication server, wherein the mobile terminal contains software or hardware logic adapted to generate a service call to the communication server comprising a command message and a destination dial-out number, the method comprising the steps of:
i) the user of the mobile terminal dials out the destination dial-out number;
ii) the adapted software or hardware logic on the mobile terminal, stores the destination dial-out number in a temporary buffer and dials out instead a predefined number for the communication server;
iii) the communication server rejects the incoming call from the mobile terminal and immediately calls back said mobile terminal;
iv) the communication server sends a server message to the mobile terminal informing that it is ready to receive commands;
v) the mobile terminal broadcasts signals to the communication server with the command message and dial-out destination number;
vi) the communication server receives and analyzes the command message, and then sends a server message to the mobile terminal informing that the command message was well received, and that the mobile terminal should stop broadcasting signals to the communication server; and
vii) the communication server acts upon the command message.

29. A communication system comprising a mobile terminal and a communication server, wherein the mobile terminal contains software or hardware logic adapted to contact said communication server, and the interaction between said communication server and said mobile terminal is carried out by the following steps:
i) the user of the mobile terminal dials out a destination dial-out number;
ii) the adapted software or hardware logic on the mobile terminal stores the destination dial-out number in a temporary buffer and dials out instead a first communication server number;
iii) the communication server rejects the first incoming call from the mobile terminal;
iv) the adapted software or hardware logic on the mobile terminal then dials out a second communication server number;
v) the communication server rejects the second incoming call from the mobile terminal;
vi) the communication server deducts, based on said first communication server number dialed and said second communication server number dialed, the telephone number of the mobile terminal and the destination dial-out number dialed by the user of said mobile terminal;
vii) the communication server then calls back said mobile terminal;
viii) the communication server then calls the destination dial-out number; and
ix) the communication server then connects the destination dial-out number and said mobile terminal.
